(19) United States
(12) Patent Application Publication
(10) Pub. No.: US 2013/0160239 A1
(43) Pub. Date: Jun. 27, 2013

(54) ADJUSTABLE CASEMENT WINDOW SNUBBER

(71) Applicant: Corby Weron, Centerville, SD (US)

(72) Inventor: Corby Weron, Centerville, SD (US)

(21) Appl. No.: 13/334,986

(22) Filed: Dec. 22, 2011

(51) Int. Cl. E05F 5/00; B23P 11/00

(52) U.S. Cl. 16/82; 29/525.01

(57) ABSTRACT

Snubbers are used to secure casement windows against negative loading. One such snubber is adjustable and includes a base having a major axis and a minor axis orthogonal to the major axis, wherein a length of the base along a major axis is greater than a width of the base along the minor axis. A flange projects from the base in a direction substantially orthogonal to both the major axis and the minor axis. The base also defines at least one slot having a slot axis, wherein the slot axis is oblique to both the major axis and the minor axis.

Snubbers are utilized in casement windows to strengthen them during negative loading of the window. Negative loading typically occurs when a window sash is forced outward from the frame. This may occur due to excessive air pressures within a building in which the window is installed, or if the window is pushed by an occupant or pulled by an intruder. Snubbers installed on both the window frame and the window sash help prevent failure of the window under such circumstances. These devices also help minimize sash warping and are utilized to improve weather strip compression on the hinged side of the window. Proper weather strip compression is important to minimize unwanted infiltration and exfiltration.

In general, one snubber is mounted to the frame of the window, and the other is mounted to the hinged window sash. As the window closes, the two snubbers engage at a bearing interface to help support the sash during negative loading, and also to ensure that the weather stripping has sufficient compression to seal the sash to the frame. In this regard, proper alignment of the snubbers is critical to properly seal the windows. Additionally, as weather seals compress or degenerate over time, it may be desirable to move either or both of the snubbers, thus bringing the sash into a tighter fit with the frame. Movement of the snubbers, however, requires removal and reinstallation of the fasteners, which makes additional, undesirable, penetrations in the frame and sash.

### SUMMARY

In one aspect, the technology relates to a snubber for a casement window, the snubber including: a base having a major axis and a minor axis orthogonal to the major axis, wherein a length of the base along a major axis is greater than a width of the base along the minor axis; and a flange projecting from the base in a direction substantially orthogonal to both the major axis and the minor axis, wherein the base defines at least one slot having a slot axis, wherein the slot axis is oblique to both the major axis and the minor axis. In an embodiment, the flange has a lip defining a lip axis oblique to the minor axis. In another embodiment, the slot axis defines an angle of about less than about 20 degrees from the major axis. In yet another embodiment, the slot axis defines an angle of about 20 degrees to about 5 degrees from the major axis. In still another embodiment, the slot axis defines an angle of about 15 degrees from the major axis. In another embodiment, the slot includes a plurality of projections.

In another aspect, the technology relates to a method of securing to a first window element a first snubber having a base having a major axis and a minor axis orthogonal to the major axis, and defining at least one slot having a slot axis, wherein the slot axis is oblique to both the major axis and the minor axis, the method including: passing a fastener through the slot; adjustably securing the fastener in a first position to the window element; placing the first snubber in contact with a second snubber located on an opposing window element, such that the first snubber moves from the first position to a second position; and securing the fastener in the second position to the window element. In an embodiment, the method includes securing the second snubber to the opposing window element. In another embodiment, the method includes manually adjusting the second position of the first snubber.

### BRIEF DESCRIPTION OF THE DRAWINGS

There are shown in the drawings, embodiments which are presently preferred, it being understood, however, that the technology is not limited to the precise arrangements and instrumentalities shown.

FIG. 1A is a front perspective view of a snubber for a casement window.

FIG. 1B is a rear perspective view of the snubber of FIG. 1A.

FIG. 1C is a rear view of the snubber of FIG. 1A.

FIG. 1D is an end view of the snubber of FIG. 1A.

FIG. 1E is a top view of the snubber of FIG. 1A.

FIG. 2 is a partial top view of a snubber for a casement window.

FIG. 3A is a top view of a casement window utilizing the snubber of FIG. 1A in an open position.

FIG. 3B is a top view of the casement window of FIG. 3A in a closed position.

FIG. 4 depicts a method of installing a snubber on a casement window.

### DETAILED DESCRIPTION

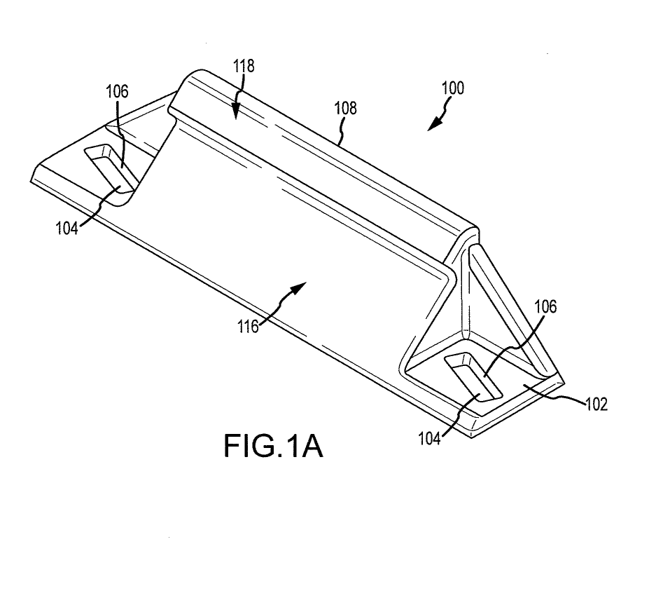

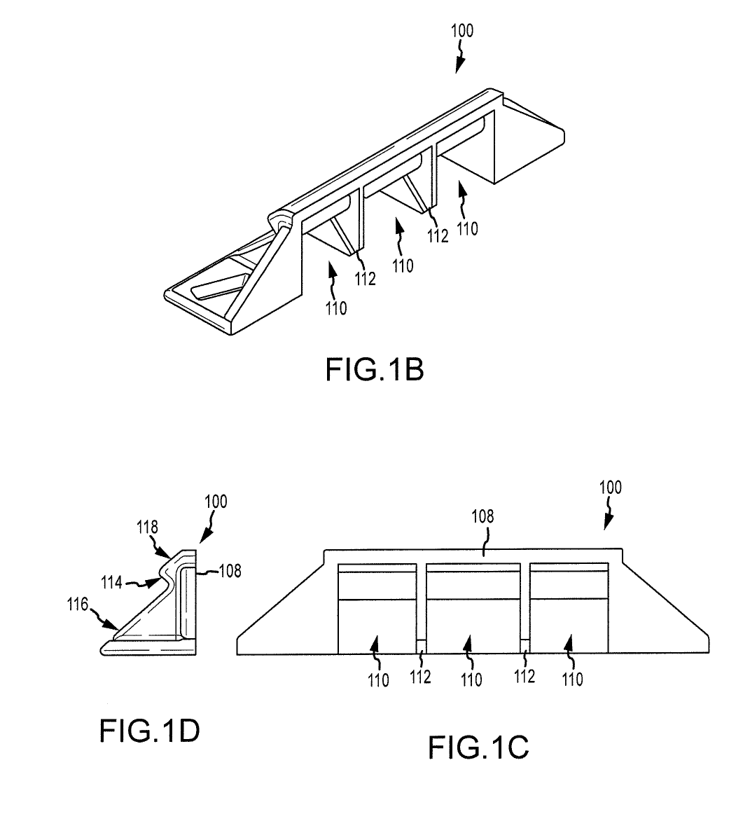

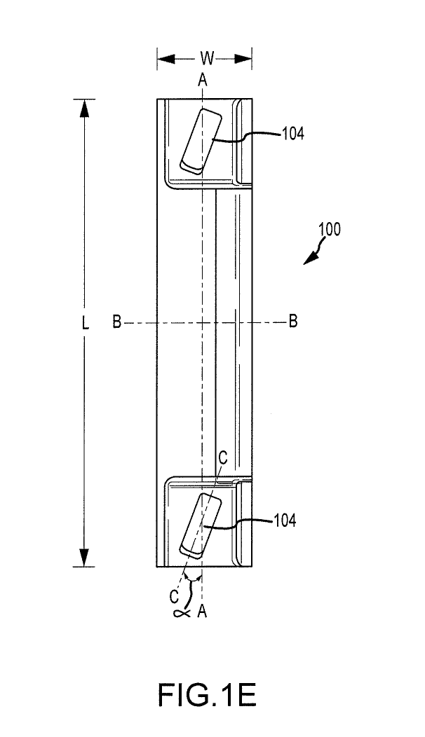

FIGS. 1A-1E depict various views of a snubber 100 for a casement window. This snubber 100 offers mounting adjustability that helps streamline the mounting process and also allows the snubber 100 to be adjusted well after installation to accommodate changes in frame closure position due to weather seal compression. The snubber 100 includes a base 102 that defines a length L along a major axis A, as well as a width W along a minor axis B. The major axis A and the minor axis B are substantially orthogonal to each other. The base 102 also includes two slots 104 that each define an axis that is oblique to both the major A and minor B axes. In the depicted embodiment, this slot axis C defines an angle a that is about 15 degrees from the major axis A. In other embodiments, the slot axis C may be less than about 20 degrees from the major axis A, less than about 15 degrees from the major axis A, or less than about 10 degrees from the major axis A. In another embodiment, the slot axis C may be about 20 degrees to about 5 degrees from the major axis A.

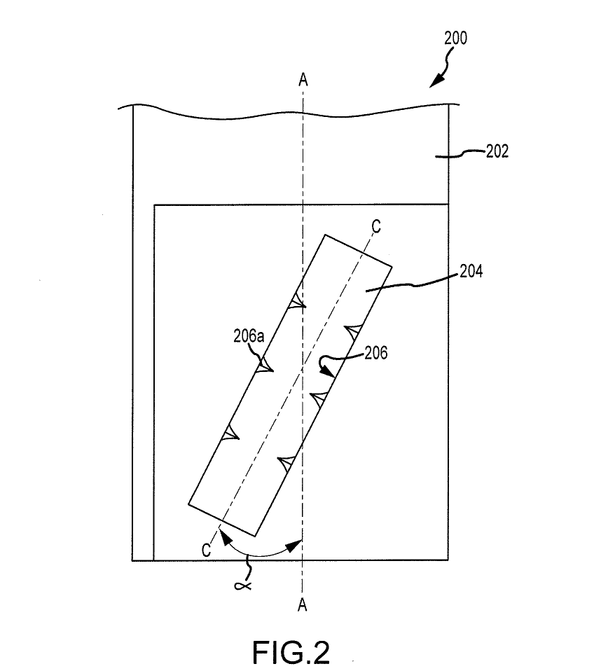

The angled slot 104 allows the snubber 100 to be adjusted either during or after installation. It has been determined that the angle a helps limit movement of the snubber (and therefore, the sash) when the sash is under negative loading. When installed, a screw, nail, bolt, or other fastener that bears against the wall 106 of each of the slots 104. If the angle a is too steep (relative to the major axis A) the snubber may break free, loosening from the screws. In that regard, the angles a discussed above have been found to be desirable in limiting movement of the snubber 100. Additionally or alternatively, the slot may include elements that help reduce the possibility of movement of the snubber relative to the fixed screw. Such an embodiment is depicted in FIG. 2, where a snubber includes a base 202 that defines a slot 204. In this case, the walls 206 of the slot 204 include one or more projections 206a that provide a surface against which an installation screw may bear during loading. Slots having this configuration may be particularly useful in embodiments of the snubber where the slot angle α is greater than 20 degrees, although snubbers having slot angles a less than 20 degrees may also benefit from this configuration.

Returning to FIGS. 1A-1E, the snubber 100 includes a flange 108 that projects substantially orthogonally from the base 102. In that regard, the flange 108 is substantially orthogonal to both the major axis A and minor axis B. The flange 108 may define a number of recesses 110 that reduce the material used in the manufacture of each of the snubbers 100. The recesses 110 are partially defined by one or more struts 112 that resist deflection of the snubber 100 during negative loading. The flange 108 also includes a lip 114 and a face 116. Opposing lips 114 on two snubbers installed on a window bear against each other during negative loading, thus preventing the window sash from being forced open. A number of different lip angles are contemplated. In certain embodiments, the lip 114 may be substantially orthogonal to the face 116. A flange bearing surface 118 is usually parallel to the face 116 such that these faces on opposing snubbers 100 can bear against each other when the window sash is under negative loading.

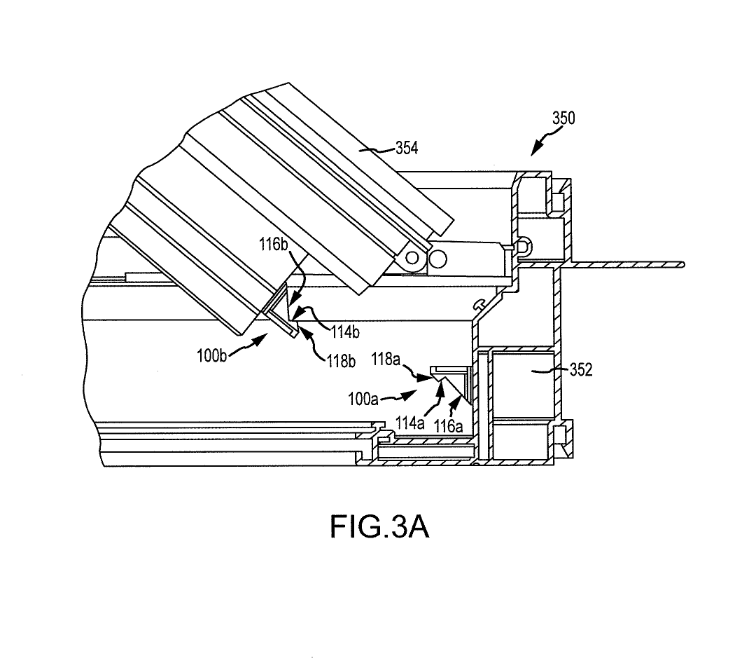

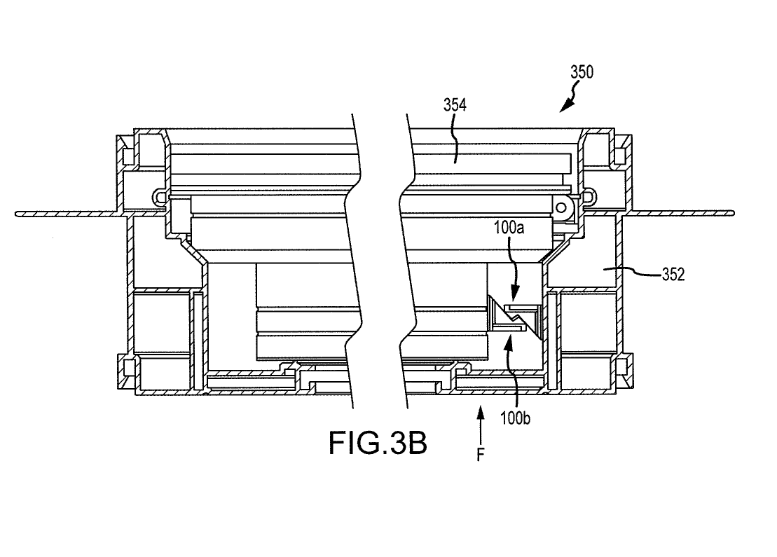

FIGS. 3A and 3B depict a pair of snubbers 100 installed on a casement window 350. The casement window 350 includes a window frame 352 and a window sash 354 pivotably connected to the frame 352. As the sash 354 pivots from the open position of FIG. 3A to the closed position of FIG. 3B, the snubbers 100a and 100b come into engaging contact. In the closed position, the flange lips 114a, 114b are in contact with each other. Additionally, the flange bearing surface 118a on the first snubber 100a contacts the face 116b of the second flange 100b. Similarly, the flange bearing surface 118b on the second snubber 100b contacts the face 116a of the first flange 100a. These various engaging surfaces prevent movement of the sash 354 when a negative load or force F is applied to the window sash 354.

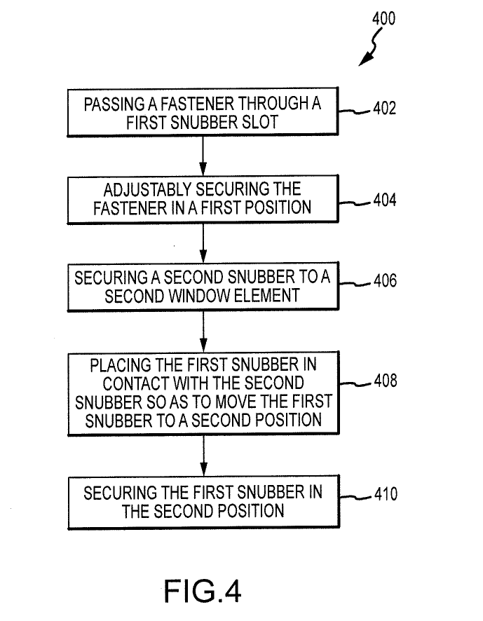

FIG. 4 depicts a method 400 of securing a snubber to a window element. The window element may be a window frame or a window sash. For clarity, however, the method 400 will be described as attaching a first snubber to a window frame, and a second snubber to a window sash. It is clear, however, that the first snubber may be attached to the sash and the second snubber attached to the frame. The method 400 includes passing a fastener such as a screw, bolt, or nail through a slot on a first snubber (Step 402). The first snubber is then adjustably secured to a window frame in a first position (Step 404). The adjustably securing step is desirable because when the second snubber is later placed in contact with the first snubber, the first snubber will move into a second, more desirable position. Of course, if the snubber includes multiple slots, a fastener should be inserted through each slot and adjustably secured to the frame. The first position is generally a position close to a desirable position. However, since the adjustable snubber described herein is useful in accommodating weatherstripping having different sizes and compressed positions, the desired position may not necessarily be known when first installing the snubber. A second snubber is secured to the window sash (Step 406). Of course, Step 406 may also be performed prior to Step 404. It is desirable, however, that the second snubber is sufficiently secured to the window sash, so as to force the adjustably secured first snubber into the second position.

The first and second snubbers are then placed in contact (Step 408). This occurs when the window sash is closed relative to the window frame (as depicted in FIG. 3B). This contact forces the first snubber into a second position. Usually, this would be the desirable position, as it will likely accommodate the space required by the compressed weatherstripping. If desired, the position of the first snubber may be further adjusted manually, so as to increase or decrease the compression of the weatherstripping or otherwise align the contacting surfaces of the snubbers. Once the desired second position is obtained, the first snubber is secured to the window frame (Step 410).

It is contemplated that a single snubber is used on each of a window frame and a mating sash. However, certain casement windows may benefit from more than one pair of snubbers. The entire snubber may be manufactured by known techniques using injection molded plastics, including PVC, ABS, various grade densities of polyethylene, or other plastics typically used in the fenestration industry. Glass-filled plastics, such as 30% glass-filled nylon may be desirable, since they allow a certain degree of deflection under load while still maintaining sufficient strength. Additionally, the snubber may be manufactured of stainless steel, brass, zinc, or other metals.

While there have been described herein what are to be considered exemplary and preferred embodiments of the present technology, other modifications of the technology will become apparent to those skilled in the art from the teachings herein. The particular methods of manufacture and geometries disclosed herein are exemplary in nature and are not to be considered limiting. It is therefore desired to be secured in the appended claims all such modifications as fall within the spirit and scope of the technology. Accordingly, what is desired to be secured by Letters Patent is the technology as defined and differentiated in the following claims, and all equivalents.

What is claimed is:

1. A snubber for a casement window, the snubber comprising:
a base comprising a major axis and a minor axis orthogonal to the major axis, wherein a length of the base along a major axis is greater than a width of the base along the minor axis; and
a flange projecting from the base in a direction substantially orthogonal to both the major axis and the minor axis,
wherein the base defines at least one slot comprising a slot axis, wherein the slot axis is oblique to both the major axis and the minor axis.

2. The snubber of claim 1, wherein the flange comprises a lip defining a lip axis oblique to the minor axis.

3. The snubber of claim 1, wherein the slot axis defines an angle of about less than about 20 degrees from the major axis.

4. The snubber of claim 1, wherein the slot axis defines an angle of about 20 degrees to about 5 degrees from the major axis.

5. The snubber of claim 1, wherein the slot axis defines an angle of about 15 degrees from the major axis.

6. The snubber of claim 1, wherein the slot comprises a plurality of projections.

7. A method of securing to a first window element a first snubber comprising a base having a major axis and a minor axis orthogonal to the major axis, and defining at least one slot comprising a slot axis, wherein the slot axis is oblique to both the major axis and the minor axis, the method comprising:
passing a fastener through the slot;
adjustably securing the fastener in a first position to the window element;
placing the first snubber in contact with a second snubber located on an opposing window element, such that the first snubber moves from the first position to a second position; and
securing the fastener in the second position to the window element.

8. The method of claim 7, further comprising securing the second snubber to the opposing window element.

9. The method of claim 7, further comprising manually adjusting the second position of the first snubber.
